(19) United States
(12) Patent Application Publication
(10) Pub. No.: US 2023/0276365 A1
(43) Pub. Date: Aug. 31, 2023

(54) SYSTEM AND METHOD FOR AMBIENT TEMPERATURE AND BATTERY VOLTAGE COMPENSATION FOR OPERATION OF A TELEMATICS MODULE THROUGH AN IGNITION-OFF LOW-POWER MODE

(71) Applicant: GM BLOBAL TECHNOLOGY OPERATIONS LLC, Detroit, MI (US)

(72) Inventors: Scott T. Droste, West Bloomfield, MI (US); Alex J. Veloso, Rochester Hills, MI (US); Reza Amini, Bloomfield, MI (US)

(73) Assignee: GM GLOBAL TECHNOLOGY OPERATIONS LLC, Detroit, MI (US)

(21) Appl. No.: 17/680,824

(22) Filed: Feb. 25, 2022

(51) Int. Cl. H04W 52/02; B60R 16/033; H02J 7/00; H01M 10/48

(52) U.S. Cl. CPC H04W 52/0277; B60R 16/033; H02J 7/0063; H02J 7/0042; H01M 10/486

(57) ABSTRACT

A system for ambient temperature and battery voltage compensation for operation of a telematics module through an ignition-off low-power mode is provided. The system includes the telematics module configured for providing data communication and for operating in the ignition-off low-power mode through a telematics remaining reduced power operating period. The system further includes a battery system providing electrical power to the telematics module, a battery voltage sensor measuring a battery voltage of the battery system, and an ambient temperature sensor measuring an ambient temperature. The system further includes a computerized ignition-off low-power controller, including programming to periodically monitor the battery voltage, periodically monitor the ambient temperature, and determine a relative energy consumption ratio based upon comparing the measured values to nominal values. The computerized ignition-off low-power controller further includes programming to adjust the operating period based upon the relative energy consumption ratio.

### INTRODUCTION

The disclosure generally relates to a system and method for ambient temperature and battery voltage compensation for operation of a telematics module through an ignition-off low-power mode.

A device may include a battery system useful for providing electrical power as a limited or budgeted amount of energy to power a telematics module at an ignition-off low-power mode state.

### SUMMARY

A system for ambient temperature and battery voltage compensation for operation of a telematics module through an ignition-off low-power mode is provided. The system includes the telematics module configured for providing data communication and media connectivity to a user of the system and for operating in the ignition-off low-power mode through a telematics remaining reduced power operating period. The system further includes a battery system configured for providing electrical power to the telematics module, a battery voltage sensor configured for measuring a battery voltage of the battery system, and an ambient temperature sensor configured for measuring an ambient temperature. The system further includes a computerized ignition-off low-power controller, including programming to periodically monitor the battery voltage, periodically monitor the ambient temperature, and determine a relative energy consumption ratio based upon comparing the battery voltage to a nominal battery voltage and comparing the ambient temperature to a nominal ambient temperature. The computerized ignition-off low-power controller further includes programming to adjust the telematics remaining reduced power operating period based upon the relative energy consumption ratio.

In some embodiments, determining the relative energy consumption ratio includes referencing a stored look-up table configured for providing the relative energy consumption ratio based upon the battery voltage and the ambient temperature.

In some embodiments, determining the relative energy consumption ratio includes periodically updating the relative energy consumption ratio to an updated relative energy consumption ratio based upon an updated battery voltage and an updated ambient temperature. Adjusting the telematics remaining reduced power operating period includes periodically adjusting the telematics remaining reduced power operating period based upon the updated relative energy consumption ratio.

In some embodiments, the computerized ignition-off low-power controller further includes programming to selectively deactivate the ignition-off low-power mode based upon expiration of the telematics remaining reduced power operating period.

In some embodiments, the computerized ignition-off low-power controller further includes programming to provide a warning to the user regarding expiration of the telematics remaining reduced power operating period.

In some embodiments, periodically monitoring the battery voltage includes monitoring the battery voltage at a relatively long voltage measurement interval, wherein the relatively long voltage measurement interval is at least one minute. Periodically monitoring the ambient temperature includes monitoring the ambient temperature at a relatively long temperature measurement interval, wherein the relatively long temperature measurement interval is at least one minute.

In some embodiments, the relatively long voltage measurement interval is equal to the relatively long temperature measurement interval.

According to one alternative embodiment, a device including a system for ambient temperature and battery voltage compensation for operation of a telematics module through an ignition-off low-power mode. The device includes the telematics module configured for providing data communication and media connectivity to a user of the system and for operating in the ignition-off low-power mode through a telematics remaining reduced power operating period. The device further includes a battery system configured for providing electrical power to the telematics module, a battery voltage sensor configured for measuring a battery voltage of the battery system, and an ambient temperature sensor configured for measuring an ambient temperature. The device further includes a computerized ignition-off low-power controller, including programming to periodically monitor the battery voltage, periodically monitor the ambient temperature, and determine a relative energy consumption ratio based upon comparing the battery voltage to a nominal battery voltage and comparing the ambient temperature to a nominal ambient temperature. The computerized ignition-off low-power controller further includes programming to adjust the telematics remaining reduced power operating period based upon the relative energy consumption ratio.

In some embodiments, the device includes a vehicle.

In some embodiments, determining the relative energy consumption ratio includes referencing a stored look-up table configured for providing the relative energy consumption ratio based upon the battery voltage and the ambient temperature.

In some embodiments, determining the relative energy consumption ratio includes periodically updating the relative energy consumption ratio to an updated relative energy consumption ratio based upon an updated battery voltage and an updated ambient temperature. Adjusting the telematics remaining reduced power operating period includes periodically adjusting the telematics remaining reduced power operating period based upon the updated relative energy consumption ratio.

In some embodiments, the computerized ignition-off low-power controller further includes programming to selectively deactivate the ignition-off low-power mode based upon expiration of the telematics remaining reduced power operating period.

In some embodiments, the computerized ignition-off low-power controller further includes programming to provide a warning to the user regarding expiration of the telematics remaining reduced power operating period.

In some embodiments, periodically monitoring the battery voltage includes monitoring the battery voltage at a relatively long voltage measurement interval, wherein the relatively long voltage measurement interval is at least one minute. Periodically monitoring the ambient temperature includes monitoring the ambient temperature at a relatively long temperature measurement interval, wherein the relatively long temperature measurement interval is at least one minute.

In some embodiments, the relatively long voltage measurement interval is equal to the relatively long temperature measurement interval.

According to one alternative embodiment, a method for ambient temperature and battery voltage compensation for operation of a telematics module through an ignition-off low-power mode is provided. The method includes operating the telematics module configured for providing data communication and media connectivity to a user of the telematics module and for operating in the ignition-off low-power mode through a telematics remaining reduced power operating period. The method further includes operating a battery system configured for providing electrical power to the telematics module. The method further includes, within a computerized ignition-off low-power controller, periodically monitoring a battery voltage of the battery system, periodically monitoring an ambient temperature, and determining a relative energy consumption ratio based upon comparing the battery voltage to a nominal battery voltage and comparing the ambient temperature to a nominal ambient temperature. The method further includes, within the computerized ignition-off low-power controller, adjusting the telematics remaining reduced power operating period based upon the relative energy consumption ratio.

In some embodiments, determining the relative energy consumption ratio includes referencing a stored look-up table configured for providing the relative energy consumption ratio based upon the battery voltage and the ambient temperature.

In some embodiments, determining the relative energy consumption ratio includes periodically updating the relative energy consumption ratio to an updated relative energy consumption ratio based upon an updated battery voltage and an updated ambient temperature. Adjusting the telematics remaining reduced power operating period includes periodically adjusting the telematics remaining reduced power operating period based upon the updated relative energy consumption ratio.

In some embodiments, the method further includes, within the computerized ignition-off low-power controller, selectively deactivating the ignition-off low-power mode based upon expiration of the telematics remaining reduced power operating period.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates a device including a battery system and an ignition-off low-power controller configured to operate and selectively deactivate an ignition-off low-power mode for a telematics module, in accordance with the present disclosure;

FIG. 2 schematically illustrates the ignition-off low-power controller of FIG. 1, in accordance with the present disclosure;

FIG. 3 is a flowchart illustrating a method to adjust operation of a low-power ignition-off mode of a telematics module by compensating for ambient temperature and battery supply voltage, in accordance with the present disclosure; and

FIG. 4 is a flowchart illustrating a method to populate a reference table such as is referenced in FIG. 3, in accordance with the present disclosure.

### DETAILED DESCRIPTION

A battery electric vehicle includes a battery system useful to provide electrical power to the vehicle. The battery electric vehicle may depend upon the battery system to operate. Maintaining a minimum state of charge in the battery system is useful to enable use of the vehicle for some threshold period, for example, to be able to travel some threshold distance. The battery electric vehicle may limit operation of some vehicle systems after an ignition-off event based upon maintaining the minimum state of charge. However, some functionality of the vehicle systems is expected by occupants of the vehicle. A user may expect to be able to complete a telephone call, listen to a radio, or enter a new navigational route when the vehicle has been stopped. A telematics module or a system configured for providing data communication and media connectivity to a user may be operated in an ignition-off low-power mode for some period of time after an ignition-off event, thereby providing the user with continued use of telematics functions through the period of time. The reduced or low power available to the telematics module while it is in the ignition-off low-power mode may include reduced or eliminated access to wireless communications and reductions of other high energy consumption activities.

One may continuously integrate or record a total amount of the telematics module's consumed current in low-power ignition-off mode with respect to time to determine consumed energy. However, such measuring of current consumed expends electrical energy. The act of constantly or at relatively fast or relatively short intervals measuring current consumed drains electrical energy from a corresponding battery system.

In anticipation of excessive battery drain, one may set a maximum time duration of the ignition-off low-power mode, for example, anticipating a “worst case” of current drain by the operated systems and preventing the battery state of charge from falling below a threshold minimum state of charge. Such a maximum time duration based upon a worst case of current drain will frequently unnecessarily limit the period of time when the ignition-off low-power mode is operated.

Battery state of charge may be affected by outside factors. Ambient temperature may affect battery state of charge and current consumption of an electrically powered system. A system and method are provided that enable excellent use of an energy budget allocated to a telematics module for ignition-off low-power operation by compensating for vehicle ambient temperature and battery supply voltage. The ambient temperature at the vehicle and the vehicle battery voltage are periodically measured in ignition-off state and compared to nominal values to adjust the remaining allowed duration in low-power mode to allow maximum use of an allocated energy budget.

In one embodiment, the measured ambient temperature and battery voltage are used as inputs to a look-up table within the telematics module to provide an energy scaling factor with respect to nominal temperature and battery voltage operation. As such, there is no need to establish a maximum time duration in low-power mode based on “worst case” ambient temperature and battery voltage as is executed in the existing implementation. The disclosed system and method also incorporate the means to adjust the rate of periodic ambient temperature and battery voltage measurements.

A rate of consumption of energy varies as a function of ambient temperature and battery supply voltage. A system and method are provided for measuring ambient temperature and battery supply voltage values at relatively long intervals and estimating energy used at relatively short intervals between the long interval measurements. The ambient temperature and battery supply voltage is periodically measured or is measured at slow intervals. and used to determine the estimated energy used over each of a plurality of fast interval time observation windows by comparing the measured temperature-voltage measurement to a set of pre-measured set of temperature-voltage combinations to estimate the energy consumed during the time observation window. By using a “slow interval” for temperature-voltage measurements, the energy consumption incurred by continuous or relatively short interval current measurement is eliminated. Energy saved by periodically measuring the value may be retained for extended use in ignition-off low-power mode operation.

In one embodiment, a method by which the energy consumed by a telematics module operating in reduced power mode in a vehicle in an ignition-off state may be estimated based on deviation of the ambient temperature and battery supply voltage from a nominal value and may include periodic low-rate measurement of the external ambient temperature experienced by vehicle in the ignition-off state. The method may include periodic low-rate measurement of the vehicle battery supply voltage. The method may include using the periodic ambient temperature and vehicle battery voltage measurements as table lookup keys within an on-vehicle database of pre-measured relative energy consumption ratios defined with respect to a nominal ambient temperature/battery voltage pair condition. The method may include using the retrieved relative energy consumption ratio to estimate the energy consumed by the telematics module over a short-duration interval or a plurality of short-duration intervals. The method may include using the estimated energy consumed by the telematics module to modulate, control operation of, or selectively deactivate the ignition-off low-power mode of the telematics module to prevent violation of an allocated energy budget threshold, for example, based upon expiration of a telematics remaining reduced power operating period.

The disclosed method allows the energy consumed by a telematics module in reduced-power mode to be more accurately gauged or estimated by accounting for temperature and battery voltage variations during the ignition-off state without expending significant/excessive energy in the process of making those temperature and battery voltage measurements. The disclosed method allows excellent usage of the allocated energy budget for operation of the telematics module instead of using a larger portion of the allocated energy budget for constantly measuring temperature and voltage values.

In one embodiment, a system for ambient temperature and battery voltage compensation for operation of a telematics module through an ignition-off low-power mode is provided. The system includes the telematics module configured for providing data communication and media connectivity to a user of the system and for operating in the ignition-off low-power mode through a telematics remaining reduced power operating period. The system further includes a battery system configured for providing electrical power to the telematics module, a battery voltage sensor configured for measuring a battery voltage of the battery system, and an ambient temperature sensor configured for measuring an ambient temperature. The system further includes a computerized ignition-off low-power controller operating the ignition-off low-power mode, where the entire telematics system is sleeping with exception of a cellular network processor which is awake in low power mode to keep listening for remote commands coming from a back office or computerized application via cellular network that can wake up the entire system to execute once a remote command is received/listened. The system further includes programming to periodically monitor the battery voltage, periodically monitor the ambient temperature, and determine a relative energy consumption ratio based upon comparing the battery voltage to a nominal battery voltage and comparing the ambient temperature to a nominal ambient temperature. The computerized ignition-off low-power controller further includes programming to adjust the telematics remaining reduced power operating period based upon the relative energy consumption ratio.

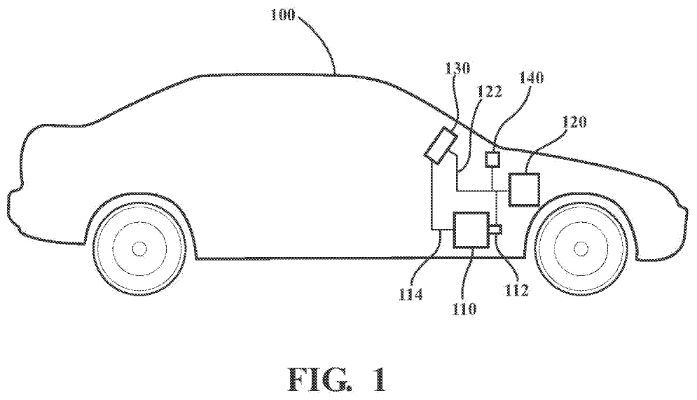

Referring now to the drawings, wherein like reference numbers refer to like features throughout the several views, FIG. 1 schematically illustrates an exemplary device 100 including a battery system 110, an ignition-off low-power mode controller 120, and a telematics module 130. The device 100 includes an exemplary vehicle. In other embodiments, the device 100 may include other electrical systems including a telematics module 130. The battery system 110 is illustrated connected to the telematics module 130 with a power cable 114, through which electrical energy is provided to the telematics module 130 for operation in various modes including an ignition-off low-power mode. A battery voltage sensor 112 is illustrated connected to or adjacent to the battery system 110 and is useful to monitor or measure a battery voltage. An ambient temperature sensor 140 is illustrated disposed within the device 100. A communications bus device 122 is illustrated connecting the ignition-off low-power controller 120, the battery voltage sensor 112, the ambient temperature sensor 140, and the telematics module 130 enabling data communication between the connected devices.

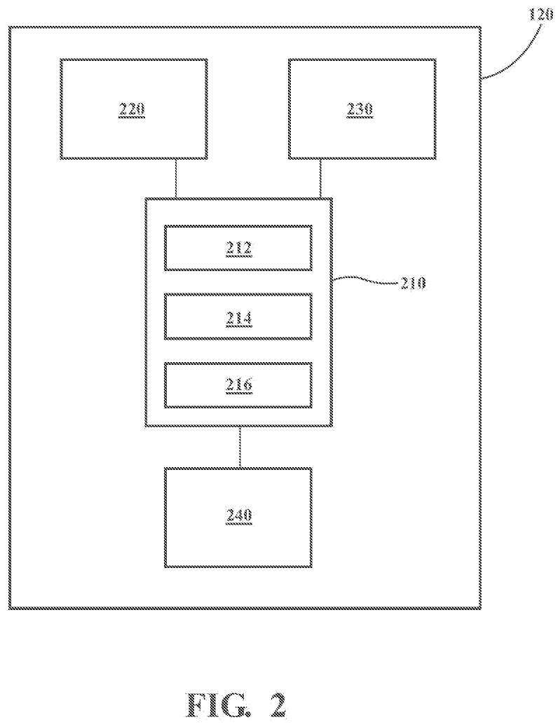

FIG. 2 schematically illustrates the computerized ignition-off low-power controller 120. Computerized ignition-off low-power controller 120 includes processing device 210, communications device 220, data input output device 230, and memory storage device 240. It is noted that computerized ignition-off low-power controller 120 may include other components and some of the components are not present in some embodiments.

The processing device 210 may include memory, e.g., read only memory (ROM) and random-access memory (RAM), storing processor-executable instructions and one or more processors that execute the processor-executable instructions. In embodiments where the processing device 210 includes two or more processors, the processors may operate in a parallel or distributed manner. Processing device 210 may execute the operating system of the computerized ignition-off low-power controller 120. Processing device 210 may include one or more modules executing programmed code or computerized processes or methods including executable steps. Illustrated modules may include a single physical device or functionality spanning multiple physical devices. In the illustrative embodiment, the processing device 210 also includes a data collection module 212, a determination module 214, and an alert/reaction module 216, which are described in greater detail below.

The data input output device 230 is a device that is operable to take data gathered from sensors and devices throughout the vehicle and process the data into formats readily usable by processing device 210. Data input output device 230 is further operable to process output from processing device 210 and enable use of that output by other devices or control modules throughout the vehicle.

The communications device 220 may include a communications/data connection with a bus device configured to transfer data to different components of the system and may include one or more wireless transceivers for performing wireless communication.

The memory storage device 240 is a device that stores data generated or received by the computerized ignition-off low-power controller 120. The memory storage device 240 may include, and is not limited to, a hard disc drive, an optical disc drive, and/or a flash memory drive.

The data collection module 212 may collect data from one or more battery voltage sensors to determine or estimate a battery voltage. The data collection module 212 may further collect data from an ambient temperature sensor to determine or estimate an ambient temperature. The data collection module 212 may store and catalog data for a current time period and may additionally include stored data related to battery voltages and ambient temperatures.

The determination module 214 receives data from the data collection module 212. The determination module 214 may utilize the method disclosed herein to compensate operation of the ignition-off low-power mode based upon battery voltage and ambient temperature. The determination module 214 may reference a look-up table stored within the memory storage device 240.

The alert/reaction module 216 may receive data or an indication from the determination module 214 and may take action based upon the data or indication. For example, the alert/reaction module 216 may set a time for or a period of time until deactivating the ignition-off low-power mode, deactivating the telematics module at the end of the period of time based upon expenditure of a defined energy budget or maintaining a minimum battery state of charge. Additionally, the alert/reaction module 216 may issue alerts or warnings to the user, for example, regarding expiration of a telematics remaining reduced power operating period, for example, stating that the telematics module is going to be deactivated in 10 minutes to preserve a minimum battery state of charge.

Computerized ignition-off low-power controller 120 is provided as an exemplary computerized device capable of executing programmed code to accomplish the methods and processes described herein. A number of different embodiments of computerized ignition-off low-power controller 120, devices attached thereto, and modules operable therein are envisioned, and the disclosure is not intended to be limited to examples provided herein.

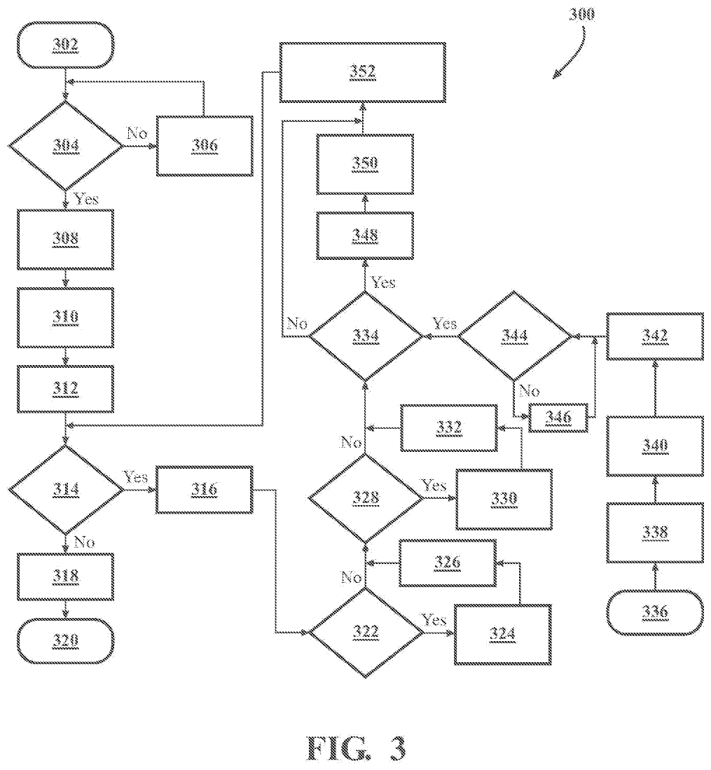

A telematics ignition-off low-power mode duration may be defined as a total time that the system is to operate in the ignition-off low-power mode, optimally consuming the allocated energy budget through operation of the telematics module through the duration. A corresponding telematics remaining reduced power operating period may be defined as a remaining portion of the telematics ignition-off low-power mode duration. FIG. 3 is a flowchart illustrating a method 300 to adjust operation of a low-power ignition-off mode of a telematics module by compensating for ambient temperature and battery supply voltage. The method 300 determines or references a relative energy consumption ratio, a, that may be used to modify a telematics ignition-off low-power mode duration or a corresponding telematics remaining reduced power operating period. A value of a below 1.0 corresponds to inefficient current consumption by the telematics module as compared to a nominal current consumption, thereby recommending a shortened telematics remaining reduced power operating period. A value of a above 1.0 corresponds to increased efficiency of current consumption by the telematics module as compared to a nominal current consumption, thereby recommending a lengthened telematics remaining reduced power operating period.

The method 300 starts at step 302. At step 304, a determination is made whether the telematics module has entered an ignition-off low-power mode. If the telematics module has not entered the ignition-off low-power mode, the method advances to step 306, where the system waits and returns to step 304. If the telematics module has entered the ignition-off low-power mode, the method advances to step 308. At step 308, the method sets a telematics remaining reduced power operating period to a nominal operating period. The nominal operating period may be initially set based upon ideal temperature and battery voltage and an estimated time that the telematics module would take to consume a budgeted amount of electrical energy at the ideal temperature and battery voltage. At step 310, a battery voltage and an ambient temperature are measured. At step 312, an update flag variable is set to TRUE. Update flag variables may be used to reset a relatively long temperature measurement interval and/or a relatively long battery voltage measurement interval, each of which are used to control how frequently new measurements of ambient temperature or battery voltage are taken. At step 314, a determination is made whether the telematics remaining reduced power operating period is greater than zero or that the telematics remaining reduced power operating period still has time left. If the telematics remaining reduced power operating period is zero, then the method advances to step 318 where the telematics module is deactivated or is powered off, and the method ends at step 320.

If, at step 314, the telematics remaining reduced power operating period is greater than zero, the method advances to step 316. At step 316, the system is commanded to wait a measuring interval period. At step 322, a determination is made whether a relatively long interval has passed since a last ambient temperature was measured. If the relatively long temperature measurement interval has passed, the method advances to step 324, where a new ambient temperature measurement is taken. At step 326, an update flag variable is set to TRUE, and the method advances to step 328. If, at step 322, the relatively long temperature measurement interval has not passed since the last ambient temperature was measured, the method advances to step 328. At step 328, a determination is made whether a relatively long voltage measurement interval has passed since a last battery voltage was measured. If the relatively long voltage measurement interval has passed, the method advances to step 330, where a new battery voltage measurement is taken. At step 332, an update flag variable is set to TRUE, and the method advances to step 334. If the relatively long voltage measurement interval has not passed, the method advances to step 334. The relatively long temperature measurement interval and the relatively long voltage measurement interval may be a single, common amount of time or a measurement interval.

In parallel to step 302 through step 334, a parallel sequence of step 336 to step 344 is operated, through which, an interrupt prompt may cause a manual or commanded set of new measurements to be taken. At step 336, the parallel sequence starts with an interrupt command, such as a control input by a user, causing the telematics module to exit the ignition-off low-power mode and establish wireless communications with a remote server. At step 338, a new ambient temperature measurement is taken. At step 340, a new battery voltage measurement is taken. At step 342, an update flag variable is set to TRUE. At step 344, a determination is made whether the telematics module re-enters the ignition-off low-power mode. If the telematics module does not re-enter the ignition-off low-power mode, the method advances to step 346, where the system waits and returns to step 344. If the telematics module does re-enter the ignition-off low-power mode, the method advances to step 334.

At step 334, a determination is made whether the update flag variable is TRUE, indicating that a new measurement of one of ambient temperature and battery voltage has recently been taken. If the update flag is TRUE, the method advances to step 348, where the update flag variable is reset to FALSE. At step 350, a relative energy consumption ratio, a, is referenced from a previously saved relative energy consumption table. Equation 1 provides an exemplary expression of a.

$$α ( voltage = {v}_{3} , temperature = {temp}_{3} ) \to [ \begin{matrix}α ( {v}_{1} , {temp}_{1} ) & α ( {v}_{1} , {temp}_{2} ) & α ( {v}_{1} , {temp}_{3} ) & … & α ( {v}_{1} , {temp}_{x} ) \\ α ( {v}_{2} , {temp}_{1} ) & α ( {v}_{2} , {temp}_{2} ) & α ( {v}_{2} , {temp}_{3} ) & … & α ( {v}_{2} , {temp}_{x} ) \\ α ( {v}_{3} , {temp}_{1} ) & α ( {v}_{3} , {temp}_{2} ) & α ( {v}_{3} , {temp}_{3} ) & … & α ( {v}_{3} , {temp}_{x} ) \\ & & … & & \\ α ( {v}_{y} , {temp}_{1} ) & α ( {v}_{y} , {temp}_{2} ) & α ( {v}_{y} , {temp}_{3} ) & & α ( {v}_{y} , {temp}_{x} )\end{matrix} ] \qquad ( 1 )$$

wherein a new measured battery voltage is correlated to value v₃ in the lookup table, and a new measured ambient temperature is correlated to value tempi in the lookup table. Table 1 is provided as an exemplary lookup table.

TABLE 1

Voltage

| Temp | 11 V | 12 V | 13 V | 14 V |
|---|---|---|---|---|
| 0° C. | 0.99 | 0.93 | 0.89 | 0.86 |
| 10° C. | 1.02 | 0.97 | 0.92 | 0.88 |
| 20° C. | 1.05 | 1 | 0.95 | 0.91 |
| 30° C. | 1.13 | 1.07 | 1.01 | 0.96 |

wherein the data from Table 1, used as a reference table in step 350, may be utilized to retrieve, access, or look up an a value. At step 352, the telematics remaining reduced power operating period is adjusted based upon the a value. Equation 2 provides an exemplary equation to adjust the telematics remaining reduced power operating period (T_{RRPO}) based upon α,

T_{RRPO}=T_{RRPO}−α·(Tₘₑₐₛ) (2)

wherein Tₘₑₐₛ is the measuring interval. After step 352, the method returns to step 314. The method 300 is exemplary, and a number of additional or alternative method steps are envisioned. The disclosure is not intended to be limited to the examples provided herein.

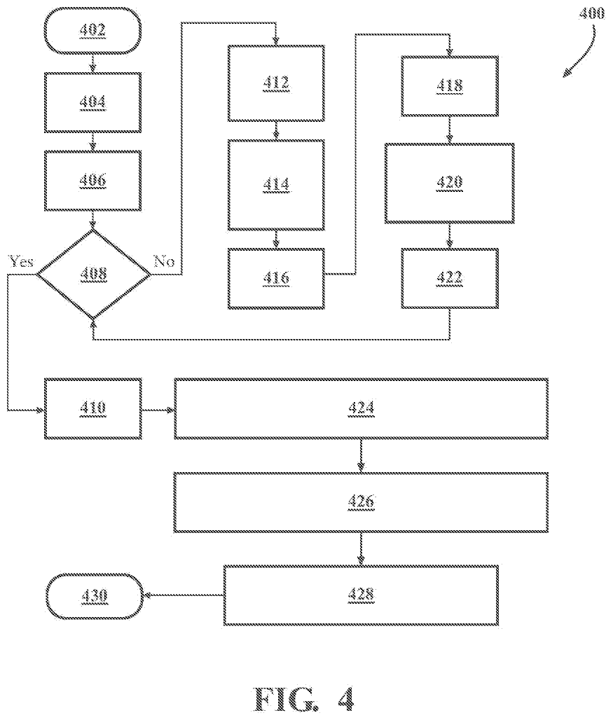

FIG. 4 is a flowchart illustrating a method 400 to populate a reference table such as is referenced in step 350 of method 300 of FIG. 3. The method 400 starts at step 402. At step 404, a set of operating battery voltage measurement points and ambient temperature measurement points are established. At step 406, a plurality of operating measurement pairs is collected, each operating measurement pair including a battery voltage and an ambient temperature (e.g., v₃ and temp₃ in Equation 1). At step 408, a determination is made, for each operating measurement pair, whether energy consumption measurements are complete. If the measurements for each operating measurement pair are not complete, the method advances to step 412. If the measurements for each operating measurement pair are complete, the method advances to step 410.

Steps 412 through 422 determine energy consumption through an observation time for one of the operating measurement pairs. In one embodiment, steps 412 through 422 may be performed once, collecting and utilizing data for each of the operating measurement pairs. In another embodiment, steps 412-422 may be operated iteratively, with each iteration taking measurements and making determinations for a different operating measurement pair. At step 412, for each of the operating measurement pairs, a test measurement condition is established (e.g., for the present operating measurement pair, the battery voltage equals 12V and the ambient temperature equals 20° C.) At step 414, a measuring interval (Tₘₑₐₛ) is established. Additionally, an observation interval (T_{obs}) is established. A total number of measurements may be determined as Tₘₑₐₛ divided by T_{obs}. At step 416, the telematics module is set to ignition-off low-power mode. At step 418, for each of the operating measurement pairs, a plurality of corresponding telematics module current consumption values at Tₘₑₐₛ intervals are measured. At step 420, for each of the operating measurement pairs through time T_{obs}, a plurality of telematics module energy consumption values (I(n)) is determined. The telematics module energy consumption may be described by Equation 3,

$$Energy = {\sum }_{n = 0}^{\frac{{T}_{meas}}{{T}_{obs}}} I ( n ) {T}_{obs} \qquad ( 3 )$$

wherein Energy is described as the total current consumption of the telematics module through the observation interval at one of the operating measurement pairs. At step 422, the total energy consumption for T_{obs} for each of the operating measurement pairs is recorded. The method then returns to step 408.

At step 410, a nominal operating voltage and temperature are selected. At step 424, a nominal operating duration is calculated. The nominal operating duration may be described by Equation 4.

$$Nominal Operating Duration = \frac{Allocated Energy Budget \times {T}_{obs}}{Energy ( nominal temperature , nominal voltage )} \qquad ( 4 )$$

At step 426, a relative energy consumption ratio, a, is calculated for reach operating measurement pair. Determination of a may be described by Equation 5.

$$α ( temperature , voltage ) = \frac{Energy ( temperature , voltage )}{Energy ( nominal temperature , nominal voltage )} \qquad ( 5 )$$

At step 428, a tabulated set of data such as is illustrated in Table 1 is generated and recorded for use as a look-up table. At step 430, the method 400 ends. The method 400 is provided as an example, and a number of additional or alternative method steps are envisioned. The disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

1. A system for ambient temperature and battery voltage compensation for operation of a telematics module through an ignition-off low-power mode, the system comprising:
the telematics module configured for continuously providing data communication and media connectivity to a user of the system and for operating in the ignition-off low-power mode through a telematics remaining reduced power operating period, wherein the telematics remaining reduced power operating period begins at an ignition-off event, and wherein the telematics remaining reduced power operating period is initially set to a nominal operating period;
a battery system configured for providing electrical power to the telematics module;
a battery voltage sensor configured for measuring a battery voltage of the battery system;
an ambient temperature sensor configured for measuring an ambient temperature;
a computerized ignition-off low-power controller, including programming to:
periodically monitor the battery voltage;
periodically monitor the ambient temperature;
determine a relative energy consumption ratio based upon comparing the battery voltage to a nominal battery voltage and comparing the ambient temperature to a nominal ambient temperature; and
selectively reduce a timespan of the telematics remaining reduced power operating period to a timespan relatively shorter than the nominal operating period based upon the relative energy consumption ratio in order to preserve a minimum battery state of charge.

2. The system of claim 1, wherein determining the relative energy consumption ratio includes referencing a stored look-up table configured for providing the relative energy consumption ratio based upon the battery voltage and the ambient temperature.

3. The system of claim 1, wherein determining the relative energy consumption ratio includes periodically updating the relative energy consumption ratio to an updated relative energy consumption ratio based upon an updated battery voltage and an updated ambient temperature; and
wherein selectively reducing the timespan of the telematics remaining reduced power operating period includes periodically adjusting the telematics remaining reduced power operating period based upon the updated relative energy consumption ratio.

4. The system of claim 1, wherein the computerized ignition-off low-power controller further includes programming to selectively deactivate the ignition-off low-power mode based upon expiration of the telematics remaining reduced power operating period.

5. The system of claim 1, wherein the computerized ignition-off low-power controller further includes programming to provide a warning to the user regarding expiration of the telematics remaining reduced power operating period.

6. The system of claim 1, wherein periodically monitoring the battery voltage includes monitoring the battery voltage at a relatively long voltage measurement interval, wherein the relatively long voltage measurement interval is at least one minute; and
wherein periodically monitoring the ambient temperature includes monitoring the ambient temperature at a relatively long temperature measurement interval, wherein the relatively long temperature measurement interval is at least one minute.

7. The system of claim 6, wherein the relatively long voltage measurement interval is equal to the relatively long temperature measurement interval.

8. A device including a system for ambient temperature and battery voltage compensation for operation of a telematics module through an ignition-off low-power mode, the device comprising:
the telematics module configured for continuously providing data communication and media connectivity to a user of the system and for operating in the ignition-off low-power mode through a telematics remaining reduced power operating period, wherein the telematics remaining reduced power operating period begins at an ignition-off event, and wherein the telematics remaining reduced power operating period is initially set to a nominal operating period;
a battery system configured for providing electrical power to the telematics module;
a battery voltage sensor configured for measuring a battery voltage of the battery system;
an ambient temperature sensor configured for measuring an ambient temperature;
a computerized ignition-off low-power controller, including programming to:
periodically monitor the battery voltage;
periodically monitor the ambient temperature;
determine a relative energy consumption ratio based upon comparing the battery voltage to a nominal battery voltage and comparing the ambient temperature to a nominal ambient temperature; and
selectively reduce a timespan of the telematics remaining reduced power operating period to a timespan relatively shorter than the nominal operating period based upon the relative energy consumption ratio in order to preserve a minimum battery state of charge.

9. The device of claim 8, wherein the device includes a vehicle.

10. The device of claim 8, wherein determining the relative energy consumption ratio includes referencing a stored look-up table configured for providing the relative energy consumption ratio based upon the battery voltage and the ambient temperature.

11. The device of claim 8, wherein determining the relative energy consumption ratio includes periodically updating the relative energy consumption ratio to an updated relative energy consumption ratio based upon an updated battery voltage and an updated ambient temperature; and
wherein selectively reducing the timespan of the telematics remaining reduced power operating period includes periodically adjusting the telematics remaining reduced power operating period based upon the updated relative energy consumption ratio.

12. The device of claim 8, wherein the computerized ignition-off low-power controller further includes programming to selectively deactivate the ignition-off low-power mode based upon expiration of the telematics remaining reduced power operating period.

13. The device of claim 8, wherein the computerized ignition-off low-power controller further includes programming to provide a warning to the user regarding expiration of the telematics remaining reduced power operating period.

14. The device of claim 8, wherein periodically monitoring the battery voltage includes monitoring the battery voltage at a relatively long voltage measurement interval, wherein the relatively long voltage measurement interval is at least one minute; and
wherein periodically monitoring the ambient temperature includes monitoring the ambient temperature at a relatively long temperature measurement interval, wherein the relatively long temperature measurement interval is at least one minute.

15. The device of claim 14, wherein the relatively long voltage measurement interval is equal to the relatively long temperature measurement interval.

16. A method for ambient temperature and battery voltage compensation for operation of a telematics module through an ignition-off low-power mode, the method comprising:
operating the telematics module, wherein the telematics module is configured for continuously providing data communication and media connectivity to a user of the telematics module and for operating in the ignition-off low-power mode through a telematics remaining reduced power operating period, wherein the telematics remaining reduced power operating period begins at an ignition-off event, and wherein the telematics remaining reduced power operating period is initially set to a nominal operating period;
operating a battery system configured for providing electrical power to the telematics module;
within a computerized ignition-off low-power controller,
periodically monitoring a battery voltage of the battery system;
periodically monitoring an ambient temperature;
determining a relative energy consumption ratio based upon comparing the battery voltage to a nominal battery voltage and comparing the ambient temperature to a nominal ambient temperature; and
selectively reducing a timespan of the telematics remaining reduced power operating period to a timespan relatively shorter than the nominal operating period based upon the relative energy consumption ratio in order to preserve a minimum battery state of charge.

17. The method of claim 16, wherein determining the relative energy consumption ratio includes referencing a stored look-up table configured for providing the relative energy consumption ratio based upon the battery voltage and the ambient temperature.

18. The method of claim 16, wherein determining the relative energy consumption ratio includes periodically updating the relative energy consumption ratio to an updated relative energy consumption ratio based upon an updated battery voltage and an updated ambient temperature; and
wherein selectively reducing the timespan of the telematics remaining reduced power operating period includes periodically adjusting the telematics remaining reduced power operating period based upon the updated relative energy consumption ratio.

19. The method of claim 16, further comprising, within the computerized ignition-off low-power controller, selectively deactivating the ignition-off low-power mode based upon expiration of the telematics remaining reduced power operating period.
